(19) United States
(12) Patent Application Publication
(10) Pub. No.: US 2024/0127574 A1
(43) Pub. Date: Apr. 18, 2024

(54) IMAGING SYSTEM, METHOD USED IN IMAGING SYSTEM, AND STORAGE MEDIUM STORING COMPUTER PROGRAM USED IN IMAGING SYSTEM

(71) Applicant: Panasonic Intellectual Property Management Co., Ltd., Osaka (JP)

(72) Inventors: TAKAYUKI KIYOHARA, Osaka (JP); MOTOKI YAKO, Osaka (JP); KATSUYA NOZAWA, Osaka (JP)

(21) Appl. No.: 18/534,636

(22) Filed: Dec. 10, 2023

Related U.S. Application Data
(63) Continuation of application No. PCT/JP2022/023788, filed on Jun. 14, 2022.

(30) Foreign Application Priority Data
Jun. 24, 2021 (JP) 2021-104609

(51) Int. Cl. G06V 10/60; G06T 7/50; G06V 10/74; G06V 10/764; G06V 20/70

(52) U.S. Cl. CPC G06V 10/60; G06T 7/50; G06V 10/761; G06V 10/764; G06V 20/70; G06T 2207/10036

(57) ABSTRACT

There is provided an imaging system including: a filter array that includes filters having different transmission spectra; an image sensor that images light passing through the filter array and generates image data; and a processing circuit, in which the processing circuit acquires luminance pattern data generated on the basis of subject data that includes spectral information of at least one substance, the luminance pattern data being generated by predicting a luminance pattern detected when the substance is imaged by the image sensor, acquires first image data obtained by imaging a target scene by the image sensor, and generates output data regarding whether the substance is present in the target scene by comparing the luminance pattern data with the first image data.

### BACKGROUND

### 1. Technical Field

The present disclosure relates to an imaging system, a method used in an imaging system, and a storage medium storing a computer program used in an imaging system.

### 2. Description of the Related Art

A process of classifying one or more subjects present in an image by type is an essential process in the factory automation and medical fields. In the classification process, feature values, such as spectral information and shape information, of the subjects are used. With a hyperspectral camera, a hyperspectral image that includes a lot of spectral information on a pixel-by-pixel basis can be obtained. Therefore, the use of a hyperspectral camera in the classification process as described above is expected.

U.S. Pat. No. 9,599,511 and International Publication No. 2020/080045 disclose an imaging apparatus that obtains a hyperspectral image by using a technique of compressed sensing.

### SUMMARY

One non-limiting and exemplary embodiment provides an imaging system that can reduce the processing load for classifying a subject present in an image by type.

In one general aspect, the techniques disclosed here feature an imaging system including: a filter array that includes filters having different transmission spectra; an image sensor that images light passing through the filter array and generates image data; and a processing circuit, in which the processing circuit acquires luminance pattern data generated on the basis of subject data that includes spectral information of at least one substance, the luminance pattern data being generated by predicting a luminance pattern detected when the substance is imaged by the image sensor, acquires first image data obtained by imaging a target scene by the image sensor, and generates output data regarding whether the substance is present in the target scene by comparing the luminance pattern data with the first image data.

According to the techniques of the present disclosure, an imaging system that can reduce the processing load for classifying a subject present in an image by type can be provided.

It should be noted that general or specific embodiments may be implemented as a system, an apparatus, a method, an integrated circuit, a computer program, a computer-readable storage medium, or any selective combination thereof. Examples of a computer-readable storage medium include a nonvolatile storage medium, such as a CD-ROM (Compact Disc Read-Only Memory). An apparatus may be constituted by one or more apparatuses. When an apparatus is constituted by two or more apparatuses, the two or more apparatuses may be disposed in one device or may be separately disposed in two or more separate devices. In the specification and the claims, “apparatus” can mean not only a single apparatus but also a system constituted by apparatuses. The apparatuses included in “system” can include an apparatus that is installed at a remote location away from the other apparatuses and connected via a communication network.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram for explaining relationships between a target wavelength range and bands included in the target wavelength range;

FIG. 1B is a diagram schematically illustrating an example hyperspectral image;

FIG. 2A is a diagram schematically illustrating an example of a filter array;

FIG. 2B is a diagram illustrating an example transmission spectrum of a first filter included in the filter array illustrated in FIG. 2A;

FIG. 2C is a diagram illustrating an example transmission spectrum of a second filter included in the filter array illustrated in FIG. 2A;

FIG. 2D is a diagram illustrating an example spatial distribution of the transmittance of light in each of bands W₁, W₂, . . . , and Wᵢ included in the target wavelength range;

FIG. 3 is a diagram schematically illustrating example fluorescence spectra of four types of fluorescent dyes A to D;

FIG. 4 is a block diagram schematically illustrating a configuration of an imaging apparatus according to exemplary embodiment 1 of the present disclosure;

FIG. 5A is a diagram schematically illustrating a spatial distribution of luminance values in a part of a compressed image;

FIG. 5B is a diagram schematically illustrating spatial distributions of luminance in a reference region illustrated in FIG. 5A in nine luminance patterns;

FIG. 6A is a diagram schematically illustrating the fluorescence intensities of two types of fluorescent dyes in bands 1 to 8;

FIG. 6B is a diagram schematically illustrating the fluorescence intensities of the two types of fluorescent dyes in bands 1, 3, and 5;

FIG. 7A is a diagram schematically illustrating an example GUI displayed on an output device before classification of fluorescent dyes;

FIG. 7B is a diagram schematically illustrating an example GUI displayed on the output device after classification of the fluorescent dyes;

FIG. 8A is a flowchart illustrating an example of operations performed by a processing circuit in embodiment 1;

FIG. 8B is a flowchart illustrating another example of operations performed by the processing circuit in embodiment 1;

FIG. 8C is a flowchart illustrating yet another example of operations performed by the processing circuit in embodiment 1;

FIG. 9 is a block diagram schematically illustrating a configuration of an imaging system according to exemplary embodiment 2 of the present disclosure;

FIG. 10 is a block diagram schematically illustrating a configuration of an imaging system according to exemplary embodiment 3 of the present disclosure;

FIG. 11A is a flowchart illustrating an example of operations performed by a processing circuit in embodiment 3;

FIG. 11B is a flowchart illustrating an example of operations performed by an external processing circuit, between step S201 and step S202 illustrated in FIG. 11A;

FIG. 12 is a diagram schematically illustrating example imaging of a color chart by an imaging apparatus, as a target scene;

FIG. 13A is a diagram schematically illustrating example individual imaging by an imaging apparatus, of medicine sachets conveyed by a belt conveyor; and

FIG. 13B is a diagram schematically illustrating an example GUI displayed on the output device after classification of medicines.

### DETAILED DESCRIPTIONS

In the present disclosure, all or some of the circuits, units, apparatuses, members, or sections or all or some of the functional blocks in block diagrams can be implemented as, for example, one or more electronic circuits that include a semiconductor device, a semiconductor integrated circuit (IC), or an LSI (Large Scale Integration) circuit. An LSI circuit or an IC may be integrated into a single chip or may be constituted by a combination of chips. For example, functional blocks other than a memory cell may be integrated into a single chip. Although the circuit is called an LSI circuit or an IC here, the circuit is called differently depending on the degree of integration, and the circuit may be one that is called a system LSI circuit, a VLSI (Very Large Scale Integration) circuit, or a ULSI (Ultra Large Scale Integration) circuit. A field-programmable gate array (FPGA) that can be programmed after LSI manufacturing or a reconfigurable logic device that allows reconfiguration of the connections inside the LSI circuit or setup of circuit cells inside the LSI circuit can be used for the same purpose.

Furthermore, all or some of the functions or operations of any circuit, unit, apparatus, member, or section can be implemented as software processing. In this case, software is recorded to one or more ROMs, optical disks, hard disk drives, or other non-transitory storage media, and when the software is executed by a processor, functions implemented as the software are executed by the processor and a peripheral device. A system or an apparatus may include one or more non-transitory storage media to which the software is recorded, the processor, and a necessary hardware device, such as an interface.

Hereinafter, exemplary embodiments of the present disclosure will be described. Note that any of the embodiments described below is a general or specific example. Numerical values, shapes, constituent elements, the dispositions, positions, and connections of constituent elements, steps, and the order of steps described in the following embodiments are illustrative and are not intended to limit the present disclosure. Among the constituent elements described in the following embodiments, a constituent element not described in an independent claim stating the most generic concept will be described as an optional constituent element. Each of the diagrams is a schematic diagram and is not necessarily a precise diagram. Furthermore, in the diagrams, constituent elements that are substantially the same are assigned the same reference numerals, and duplicated descriptions may be omitted or briefly given.

A description of underlying knowledge forming the basis of the present disclosure will be given prior to descriptions of the embodiments of the present disclosure.

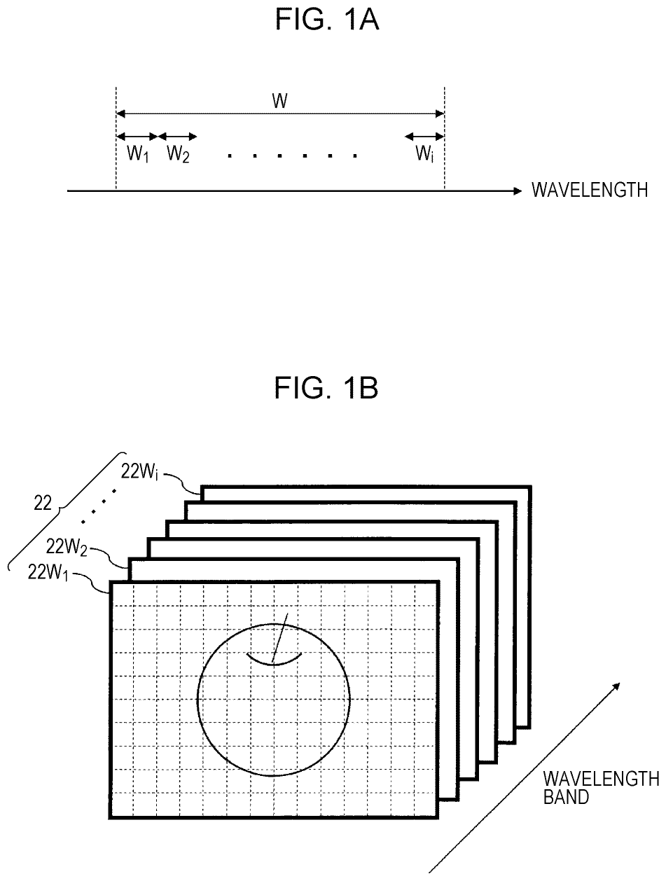

An example hyperspectral image will be first explained briefly with reference to FIG. 1A and FIG. 1B. A hyperspectral image is image data having a larger amount of wavelength information than a general RGB image. An RGB image has pixel values for three respective bands of red (R), green (G), and blue (B) on a pixel-by-pixel basis. In contrast, a hyperspectral image has pixel values for respective bands more than or equal to the three bands described above on a pixel-by-pixel basis. In the specification, “hyperspectral image” means images corresponding to four or more respective bands included in a predetermined target wavelength range. Each pixel has a value, which is referred to as “pixel value”. In the specification, pixel values of pixels included in an image may be referred to as “image”. The number of bands in a hyperspectral image is typically ten or more and may exceed 100. “Hyperspectral image” may also be called “hyperspectral data cube” or “hyperspectral cube”.

FIG. 1A is a diagram for explaining relationships between a target wavelength range W and bands W₁, W₂, . . . , and Wᵢ included in the target wavelength range W. The target wavelength range W can be set to any of various ranges in accordance with the use. The target wavelength range W can be, for example, the wavelength range of visible light from about 400 nm to about 700 nm, the wavelength range of near-infrared rays from about 700 nm to about 2500 nm, or the wavelength range of near-ultraviolet rays from about 10 nm to about 400 nm. Alternatively, the target wavelength range W may be the wavelength range of mid-infrared rays or far-infrared rays. As described above, the wavelength range to be used is not limited to the visible-light range. In the specification, not only visible light but also electromagnetic waves, such as ultraviolet rays and near-infrared rays, having wavelengths not included in the wavelength range of visible light are referred to as “light” for the sake of convenience.

In the example illustrated in FIG. 1A, the target wavelength range W is divided into i equal wavelength ranges, which are defined as the band W₁, the band W₂, . . . , and the band Wᵢ, where i is any integer greater than or equal to 4. However, the bands are not limited to this example. The bands included in the target wavelength range W may be set as desired. For example, the bandwidths corresponding to the bands may be different from each other. Bands adjacent to each other may have a gap therebetween. When the number of bands is four or more, a larger amount of information can be obtained from the hyperspectral image than from an RGB image.

FIG. 1B is a diagram schematically illustrating an example of a hyperspectral image 22. In the example illustrated in FIG. 1B, the imaging target is an apple. The hyperspectral image 22 includes an image 22W₁, an image 22W₂, . . . , and an image 22Wᵢ that correspond to the band W₁, the band W₂, . . . , and the band Wi on a one-to-one basis. Each of these images includes pixels arranged in two dimensions. In FIG. 1B, the borders of the pixels are shown in lengthwise and breadthwise dashed lines. Although the actual number of pixels per image can be a large value, such as tens of thousands to tens of millions, FIG. 1B illustrates an extremely small number of pixels in order to facilitate understanding and shows the borders of pixels. FIG. 1B illustrates the image 22W₁, the image 22W₂, . . . , and the image 22Wᵢ each including 140 pixel values (14×10=140). Light based on reflected light produced in response to irradiation of a target object with light is detected by photodetection elements in an image sensor. A signal indicating the amount of light detected by each photodetection element represents the pixel value of a pixel corresponding to the photodetection element. An image 22Wₖ included in the hyperspectral image 22 includes pixels, and each of the pixels has a pixel value relating to a band Wₖ (k is a natural number less than or equal to i). Therefore, when the hyperspectral image 22 is acquired, information about the two-dimensional distribution of the spectrum of the target object can be obtained. Based on the spectrum of the target object, the light-related characteristics of the target object can be accurately analyzed.

An example of a method for generating a hyperspectral image will now be explained briefly. A hyperspectral image can be acquired by imaging using a spectroscopic element, such as a prism or a grating. When a prism is used, reflected light or transmitted light from a target object passes through the prism and exits the prism through its exit surface at an exit angle corresponding to the wavelength. When a grating is used, reflected light or transmitted light from a target object is incident on the grating and is diffracted at a diffraction angle corresponding to the wavelength.

In a line-scan-type hyperspectral camera, a hyperspectral image is acquired as follows. An operation in which light produced in response to irradiation of a subject with a line beam is separated by a prism or a grating into light rays by band and the separated light rays are detected on a band-by-band basis is repeated each time the line beam is shifted little by little. A line-scan-type hyperspectral camera has a high spatial resolution and a high wavelength resolution while its imaging time is long due to a scan with a line beam. An existing snapshot-type hyperspectral camera need not perform a scan, and therefore, its imaging time is short while its sensitivity and spatial resolution are not so high. In an existing snapshot-type hyperspectral camera, plural types of narrowband filters having different passbands are arranged on an image sensor at regular intervals. The average transmittance of each filter is about 5%. When the number of types of narrowband filters is increased to improve the wavelength resolution, the spatial resolution decreases.

As disclosed in U.S. Pat. No. 9,599,511, a snapshot-type hyperspectral camera using a technique of compressed sensing can attain a high sensitivity and a high spatial resolution. In the technique of compressed sensing disclosed in U.S. Pat. No. 9,599,511, light reflected by a target object is detected by an image sensor through a filter array called a coding element or a coding mask. The filter array includes filters arranged in two dimensions. Each of these filters has a transmission spectrum unique to it. With imaging using such a filter array, a compressed image in which image information for bands is compressed into one two-dimensional image can be obtained. In this compressed image, spectral information of the target object is compressed into one pixel value on a pixel-by-pixel basis and recorded. In other words, each pixel included in the compressed image includes information corresponding to the bands.

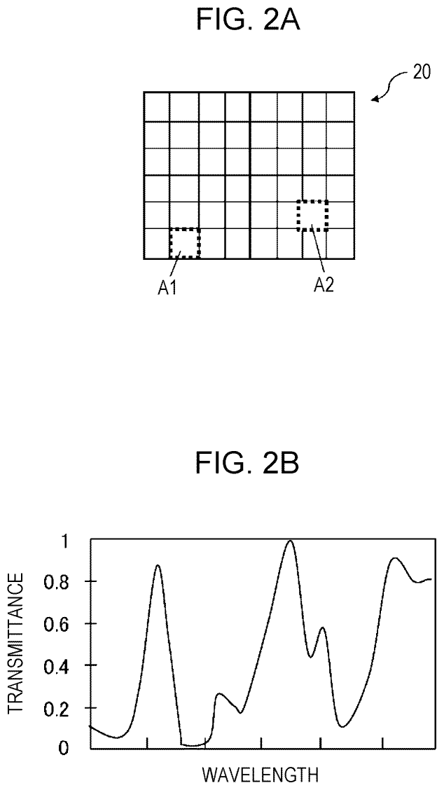

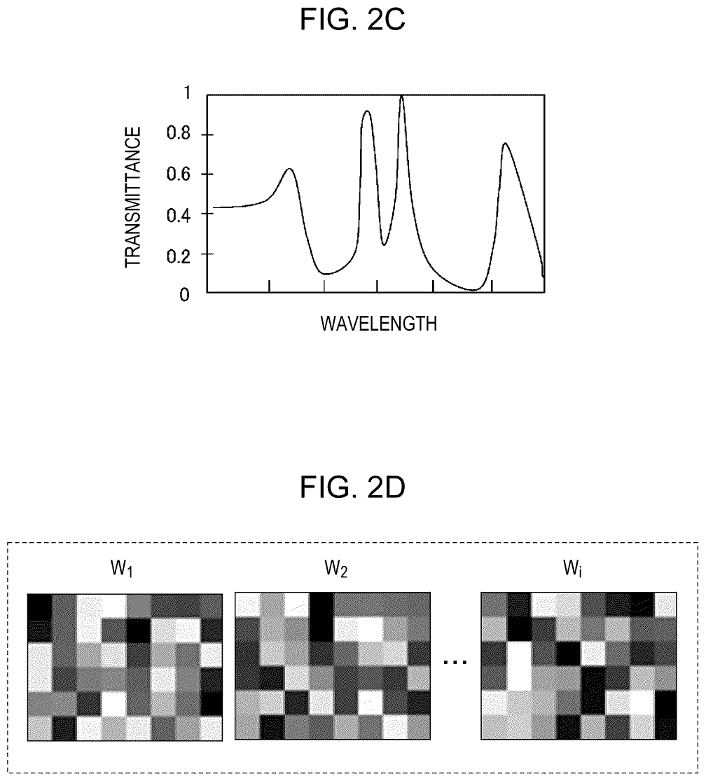

FIG. 2A is a diagram schematically illustrating an example of a filter array 20. The filter array 20 includes plural filters arranged in two dimensions. Each filter has an individually set transmission spectrum. The transmission spectrum is expressed by a function T(λ), where λ is the wavelength of incident light. The transmission spectrum T(λ) can have a value greater than or equal to 0 and less than or equal to 1. In the example illustrated in FIG. 2A, the filter array 20 has 48 rectangular filters arranged in six rows and eight columns. This is only an example, and a number of filters larger than in this example can be provided for the actual use. The number of filters included in the filter array 20 may be about the same as the number of pixels in the image sensor.

FIG. 2B and FIG. 2C are diagrams respectively illustrating example transmission spectra of a first filter A1 and a second filter A2 among the plural filters included in the filter array 20 in FIG. 2A. The transmission spectrum of the first filter A1 and the transmission spectrum of the second filter A2 are different from each other. As described above, the transmission spectrum of the filter array 20 differs depending on the filter. However, the transmission spectra of all filters need not be different. In the filter array 20, the transmission spectra of at least two or more filters among the plural filters are different from each other. That is, the filter array 20 includes plural types of filters having different transmission spectra. Each type of filter can have two or more local maxima in the target wavelength range. The plural types of filters include four or more types of filters, and among the four or more types of filters, the passband of a type of filter can overlap a part of the passband of another type of filter. In one example, the number of patterns of the transmission spectra of the plural types of filters included in the filter array 20 can be equal to or greater than the number of bands i included in the target wavelength range. The filter array 20 may be designed such that half or more of the filters have different transmission spectra.

FIG. 2D is a diagram illustrating an example spatial distribution of optical transmittance in each of the bands W₁, W₂, . . . , and Wᵢ included in the target wavelength range. In the example illustrated in FIG. 2D, different shades of gray of the respective filters represent different optical transmittances. A lighter filter has a higher optical transmittance, and a darker filter has a lower optical transmittance. As illustrated in FIG. 2D, the spatial distribution of optical transmittance differs depending on the band. In the specification, data indicating the spatial distribution of the transmission spectrum of the filter array is referred to as “reconstruction table”. With a technique of compressed sensing, a hyperspectral image can be reconstructed from a compressed image by using the reconstruction table. With a technique of compressed sensing, the use of a prism or a grating is not necessary, which can reduce the size of hyperspectral cameras. Furthermore, with a technique of compressed sensing, information about spectra is compressed into one compressed image to thereby allow a reduction in the amount of data to be processed by a processing circuit. Furthermore, each filter included in the filter array need not be a narrowband filter, which can attain a sensitivity and a spatial resolution higher than those of existing snapshot-type hyperspectral cameras.

A method for reconstructing a hyperspectral image from a compressed image by using a reconstruction table will now be described. Compressed image data g acquired by an image sensor, a reconstruction table H, and hyperspectral image data f satisfy expression (1) below.

g=Hf (1)

Here, each of the compressed image data g and the hyperspectral image data f is vector data, and the reconstruction table H is matrix data. When the number of pixels of the compressed image data g is denoted by N_{g}, the compressed image data g is expressed as a one-dimensional array or vector having N_{g} elements. When the number of pixels in each of the images included in the hyperspectral image is denoted by N_{f} and the number of wavelength bands in each of the images is denoted by M, the hyperspectral image data f is expressed as a one-dimensional array or vector having N_{f}=M elements. For example, when the images are the image 22W₁, . . . , and the image 22Wᵢ, N_{f}=140 and M=i hold. The reconstruction table H is expressed as a matrix having elements in N_{g} rows and (N_{f}×M) columns. N_{g} and N_{f} can be designed so as to be the same values.

When the vector g and the matrix H are given, it seems that f can be calculated by solving the inverse problem of expression (1). However, the number of elements N_{f}×M in the data f to be calculated is larger than the number of elements N_{g} in the acquired data g, and therefore, this problem is an ill-posed problem and is unable to be solved as is. Therefore, a solution is calculated by using redundancy of the images included in the data f and using a technique of compressed sensing. Specifically, the data f to be calculated is estimated by solving expression (2) below.

$${f}^{′} = {arg min}_{f} \{ {‖ g - Hf ‖}_{{l}_{2}} + τΦ ( f ) \} \qquad ( 2 )$$

$$g$$

The above g included in expression (1) and expression (2) may be simply described as g in a description related to expression (1) and expression (2).

Here, f′ denotes the estimated data f. The first term in the curly brackets in the above expression represents the amount of deviation of the estimation result Hf from the acquired data g, that is, a residual term. Although the residual term is the sum of squares here, the residual term may be, for example, the absolute value or the square root of the sum of squares. The second term in the curly brackets is a regularization term or a stabilization term described below. Expression (2) means calculation off with which the sum of the first term and the second term is minimized. An arithmetic processing circuit can converge the solution by recursive iterative operations and calculate the final solution f.

The first term in the curly brackets in expression (2) means an operation of calculating the sum of squares of the differences between the acquired data g and Hf obtained by system transformation of fin the process of estimation by using the matrix H. In the second term, Φ(f) is a constraint condition in regularization off and is a function that reflects sparse information about the estimated data. This function brings an effect of smoothing or stabilizing the estimated data. The regularization term can be expressed by, for example, a discrete cosine transform (DCT), a wavelet transform, a Fourier transform, or total variation (TV) off. For example, when total variation is used, stable estimated data on which the effect of noise of the observation data g is reduced can be acquired. The sparsity of a target object in the spaces of regularization terms differs depending on the texture of the target object. A regularization term with which the texture of the target object becomes sparser in the space of the regularization term may be selected. Alternatively, plural regularization terms may be included in the operation. τ is a weighting coefficient. As the weighting coefficient τ increases, the amount of reduction of redundant data increases and the compression ratio increases. As the weighting coefficient τ decreases, convergence to the solution becomes weaker. The weighting coefficient τ is set to an appropriate value with which f is converged to some extent and the data is not excessively compressed.

A more detailed method for obtaining a hyperspectral image by using a technique of compressed sensing is disclosed in U.S. Pat. No. 9,599,511. The content disclosed in U.S. Pat. No. 9,599,511 is incorporated by reference herein in its entirety.

In a hyperspectral camera using a technique of compressed sensing, compressed image data is generated before hyperspectral image data is generated. International Publication No. 2020/080045 discloses a method for recognizing a subject not with a hyperspectral image but with a compressed image. In this method, a compressed image of a known subject is first acquired, and learning data of the compressed image of the subject is generated by machine learning. Thereafter, based on the learning data, the subject present in a newly acquired compressed image is recognized. In this method, generation of hyperspectral image data is not necessary, which can reduce the processing load.

In a process of classifying a subject present in an image by type, spectral information of the subject may be known. For example, a fluorescent dye absorbs excitation light and emits fluorescence having a wavelength unique to it. Medicines and electronic components have unique spectral information with almost no individual differences if they are of the same types. A process of classifying a subject present in an image by type has been performed to date by comparing hyperspectral image data with known spectral data. With this method, generation of the hyperspectral image data increases the load of the classification process. Reducing the load of the classification process by utilizing the advantage that spectral information of the subject is known has not been considered to date.

Based on the above studies, the present inventors have conceived of an imaging apparatus according to embodiments of the present disclosure that can classify a subject by type, not by using hyperspectral image data of the subject but by using a luminance pattern of image data obtained by imaging the subject through a filter array. The imaging apparatus according to the present embodiments uses as the filter array, a coding element used in compressed sensing as disclosed in U.S. Pat. No. 9,599,511. Furthermore, compressed image data obtained through the coding element is used to classify a subject by type. The imaging apparatus according to the present embodiments can classify a subject by type without acquiring hyperspectral image data of the subject, which can reduce the load of the classification process. Furthermore, in the imaging apparatus according to the present embodiments, each filter included in the filter array need not be a narrowband filter, which can attain a high sensitivity and a high spatial resolution. An imaging system and a computer program according to the embodiments of the present disclosure will be described below.

An imaging system according to a first item includes: a filter array that includes filters having different transmission spectra; an image sensor that images light passing through the filter array and generates image data; and a processing circuit, in which the processing circuit acquires luminance pattern data generated on the basis of subject data that includes spectral information of at least one substance, the luminance pattern data being generated by predicting a luminance pattern detected when the substance is imaged by the image sensor, acquires first image data obtained by imaging a target scene by the image sensor, and generates output data regarding whether the substance is present in the target scene by comparing the luminance pattern data with the first image data.

This imaging system can reduce the processing load for classifying a subject present in an image by type.

An imaging system according to a second item is the imaging system according to the first item, further including a storage device that stores the subject data and a table showing a spatial distribution of the transmission spectra of the filter array. The processing circuit acquires the subject data and the table from the storage device and generates the luminance pattern data on the basis of the subject data and the table.

This imaging system can generate luminance pattern data without external communication.

An imaging system according to a third item is the imaging system according to the first item, further including a storage device that stores a table showing a spatial distribution of the transmission spectra. The processing circuit acquires the table from the storage device, externally acquires the subject data, and generates the luminance pattern data on the basis of the subject data and the table.

This imaging system need not store subject data in the storage device for generating luminance pattern data, which can reduce the amount of data stored in the storage device.

An imaging system according to a fourth item is the imaging system according to the first item, in which the processing circuit externally acquires the luminance pattern data.

This imaging system need not generate luminance pattern data, which can reduce the processing load.

An imaging system according to a fifth item is the imaging system according to any of the first to fourth items, in which the spectral information of the at least one substance includes spectral information of substances, and the output data is data regarding whether each of the substances is present in the target scene.

This imaging system allows the user to know whether each of the plural types of subjects is present in the target scene.

An imaging system according to a sixth item is the imaging system according to any of the first to fifth items, in which the processing circuit determines whether the substance is present in the target scene by comparing the luminance pattern data with the first image data in a reference region that includes two or more pixels.

This imaging system can determine whether the subject is present in the reference region in the target scene.

An imaging system according to a seventh item is the imaging system according to the sixth item, in which the number of the two or more pixels included in the reference region changes in accordance with the number of substances.

This imaging system can select a reference region suitable for the number of types of subjects.

An imaging system according to an eighth item is the imaging system according to the sixth or seventh item, in which a target wavelength range for which light separation is performed by the imaging system includes n bands, the two or more pixels included in the reference region include n pixels including an evaluation pixel and a pixel near the evaluation pixel, not plural substances but one substance is present in the reference region, the filter array includes n filters corresponding to the n respective pixels included in the reference region, the n filters having different transmission spectra, and each of the n filters has a transmittance that is non-zero for all of the n bands.

This imaging system can efficiently determine whether the subject is present in the reference region in the target scene.

An imaging system according to a ninth item is the imaging system according to any of the first to eighth items, in which the output data includes information about a probability of presence of the substance at each pixel of the first image data and/or information about a probability of presence of the substance at pixels, in the first image data, corresponding to an observation target.

This imaging system allows the user to know whether the subject is present in the target scene on the basis of the probability of presence of the subject.

An imaging system according to a tenth item is the imaging system according to any of the first to ninth items, in which the subject data further includes shape information of the at least one substance.

This imaging system allows the user to know whether the subject is present in the target scene on the basis of the shape of the subject.

An imaging system according to an eleventh item is the imaging system according to any of the first to tenth items, further including an output device. The processing circuit makes the output device output a result of classification indicated by the output data.

This imaging system allows the user to know the result of classification of the subject in the target scene, on the output device.

An imaging system according to a twelfth item is the imaging system according to the eleventh item, in which the output device displays an image in which a label by type is added to a part in which the substance is present in the target scene.

This imaging system allows the user to know the type of the subject present in the target scene by viewing the display on the output device.

An imaging system according to a thirteenth item is the imaging system according to the eleventh or twelfth item, in which the output device displays at least one of a graph of a spectrum of the substance or an image showing explanatory text about the substance.

This imaging system allows the user to know detailed information about the subject by viewing the display on the output device.

An imaging system according to a fourteenth item is the imaging system according to any of the eleventh to thirteenth items, in which the output device displays an image in which a label is added to an observation target, in the target scene, for which a probability of presence of the substance falls below a specific value, the label indicating that classification of a type of the observation target is not possible.

This imaging system allows the user to know the observation target for which determination fails, on the output device.

An imaging system according to a fifteenth item is the imaging system according to any of the first to fourteenth items, in which each of the filters has two or more local maxima in a target wavelength range for which light separation is performed by the imaging system.

This imaging system allows implementation of a filter array suitable for a comparison between luminance pattern data and image data.

An imaging system according to a sixteenth item is the imaging system according to any of the first to fifteenth items, in which the filters include four or more types of filters. The four or more types of filters include a type of filter having a passband that overlaps a part of a passband of another type of filter.

This imaging system allows implementation of a filter array suitable for a comparison between luminance pattern data and image data.

An imaging system according to a seventeenth item is the imaging system according to any of the first to sixteenth items, in which the first image data is compressed image data coded by the filter array. The processing circuit generates hyperspectral image data of the target scene on the basis of the compressed image data of the target scene.

This imaging system can generate hyperspectral image data of the target scene.

An imaging system according to an eighteenth item is the imaging system according to any of the eleventh to fourteenth items, in which the first image data is compressed image data coded by the filter array. The processing circuit makes the output device display a GUI for a user to give an instruction for generating hyperspectral image data of the target scene, and generates in response to the instruction given by the user, the hyperspectral image data of the target scene on the basis of the compressed image data of the target scene.

This imaging system allows the user to generate hyperspectral image data of the target scene by input to the GUI displayed on the output device.

An imaging system according to a nineteenth item is the imaging system according to any of the eleventh to fourteenth items, in which the first image data is compressed image data coded by the filter array. The processing circuit makes the output device display a GUI for a user to give an instruction for switching between a first mode for generating the output data and a second mode for generating hyperspectral image data of the target scene, generates the output data in response to an instruction for the first mode given by the user, and generates the hyperspectral image data of the target scene in response to an instruction for the second mode given by the user, on the basis of the compressed image data of the target scene.

This imaging system allows the user to switch between the first mode and the second mode by input to the GUI displayed on the output device.

A method according to a twentieth item is a method to be performed by a computer. The method includes: acquiring first image data obtained by imaging a target scene by an image sensor, the image sensor imaging light passing through a filter array that includes filters having different transmission spectra and generating image data; acquiring luminance pattern data generated on the basis of subject data that includes spectral information of at least one type of subject, the luminance pattern data being generated by predicting a luminance pattern detected when the subject is imaged by the image sensor; and generating output data indicating whether the subject is present in the target scene by comparing the luminance pattern data with the first image data.

This method can reduce the processing load for classifying a subject present in an image by type.

A computer program according to a twenty-first item is a computer program to be executed by a computer. The computer program causes the computer to perform: acquiring first image data obtained by imaging a target scene by an image sensor, the image sensor imaging light passing through a filter array that includes filters having different transmission spectra and generating image data; acquiring luminance pattern data generated on the basis of subject data that includes spectral information of at least one type of subject, the luminance pattern data being generated by predicting a luminance pattern detected when the subject is imaged by the image sensor; and generating output data indicating whether the subject is present in the target scene by comparing the luminance pattern data with the first image data, and outputting the output data.

This computer program can reduce the processing load for classifying a subject present in an image by type.

### Embodiment 1

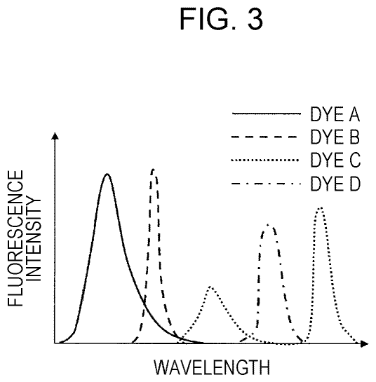

An example of performing fluorescence imaging by using an imaging apparatus according to embodiment 1 of the present disclosure will be described here. Fluorescence imaging is widely performed mainly in the biological and medical fields. In fluorescence imaging, a fluorescent dye is attached to an observation target having a specific molecule, tissue, or structure and the observation target is irradiated with excitation light to thereby acquire an image of fluorescence emitted from the fluorescent dye. As a result, the observation target can be visualized. FIG. 3 is a diagram schematically illustrating example fluorescence spectra of four types of fluorescent dyes A to D. The fluorescence spectrum of each of fluorescent dyes A, B, and D has a single peak. The peak wavelength and the peak width differ among fluorescent dyes A, B, and D. The fluorescence spectrum of fluorescent dye C has two peaks having different peak wavelengths and peak widths. As illustrated in FIG. 3, in fluorescence imaging, fluorescence spectral information of the fluorescent dyes attached to observation targets is known.

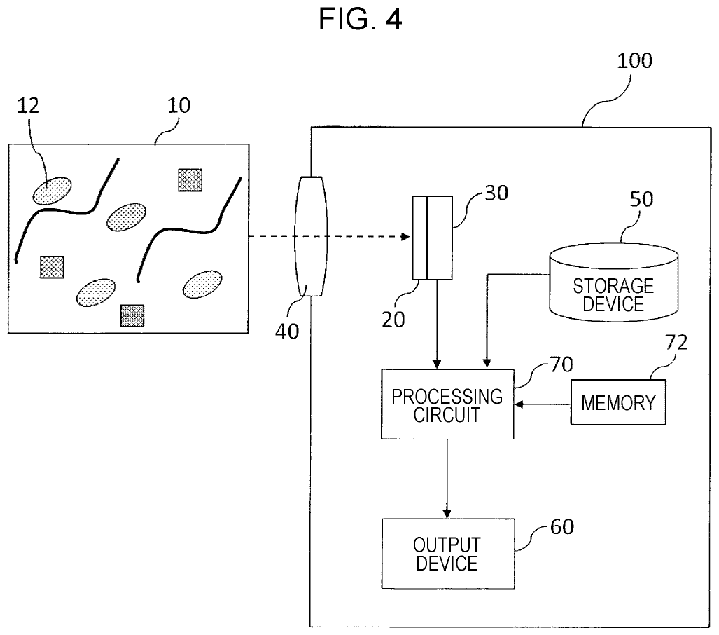

A configuration of the imaging apparatus according to exemplary embodiment 1 of the present disclosure will be described below with reference to FIG. 4. The imaging apparatus classifies plural types of fluorescent dyes attached to plural respective types of observation targets, not by using hyperspectral image data but by using compressed image data. FIG. 4 is a block diagram schematically illustrating a configuration of an imaging apparatus 100 according to exemplary embodiment 1 of the present disclosure. FIG. 4 illustrates a target scene 10 that is an imaging target. The target scene 10 includes plural types of observation targets to which plural respective types of fluorescent dyes 12 are attached. The shapes of the plural types of observation targets illustrated in FIG. 4 are an elliptic shape, a bent-line shape, and a rectangular shape. The number of types of fluorescent dyes attached to the observation targets may be more than one or may be one.

The imaging apparatus 100 illustrated in FIG. 4 includes the filter array 20, an image sensor 30, an optical system 40, a storage device 50, an output device 60, a processing circuit 70, and a memory 72. The imaging apparatus 100 functions as a hyperspectral camera. The imaging apparatus 100 may be, for example, a part of a mobile terminal or a personal computer.

The filter array 20 modulates the intensity of incident light on a filter-by-filter basis and allows the light to exit. The details of the filter array 20 are as described above.

The image sensor 30 includes photodetection elements arranged in two dimensions along a photodetection surface. In the specification, the photodetection elements are also referred to as “pixels”. The area of the photodetection surface of the image sensor 30 is approximately equal to the area of the light incident surface of the filter array 20. The image sensor 30 is disposed at a position at which light passing through the filter array 20 is received. The photodetection elements included in the image sensor 30 can correspond to, for example, the filters included in the filter array 20. One photodetection element may detect light passing through two or more filters. The image sensor 30 generates compressed image data based on light passing through the filter array 20. The image sensor 30 can be, for example, a CCD (Charge-Coupled Device) sensor, a CMOS (Complementary Metal-Oxide Semiconductor) sensor, or an infrared array sensor. Each photodetection element can include, for example, a photodiode. The image sensor 30 can be, for example, a monochrome sensor or a color sensor. The target wavelength range described above is a wavelength range that can be detected by the image sensor 30.

The optical system 40 is positioned between the target scene 10 and the filter array 20. The target scene 10 and the filter array 20 are positioned on the optical axis of the optical system 40. The optical system 40 includes at least one lens. Although the optical system 40 is constituted by one lens in the example illustrated in FIG. 4, the optical system 40 may be constituted by a combination of lenses. The optical system 40 forms an image on the photodetection surface of the image sensor 30 through the filter array 20.

The storage device 50 stores a reconstruction table corresponding to the transmission characteristics of the filter array 20 and dye data including fluorescence spectral information of plural types of fluorescent dyes. In the specification, data including spectral information of at least one type of subject in the target scene 10 is referred to as “subject data”. Each fluorescent dye in this embodiment is an example of a subject in the target scene 10. The subject may be any subject as long as its spectral information is known.

“At least one substance” described in the claims may mean “at least one type of subject” described above.

The output device 60 displays the results of classification of the plural types of fluorescent dyes included in the target scene 10. Information about the results of classification may be displayed on a GUI (Graphic User Interface). The output device 60 can be, for example, a display of a mobile terminal or a personal computer. Alternatively, the output device 60 may be a speaker that communicates the results of classification by sound. The output device 60 need not be a display or a speaker as long as the output device 60 can communicate the results of classification to the user.

The imaging apparatus 100 may transmit an instruction for making the output device 60 output the results of classification. The output device 60 may receive the instruction and output the results of classification.

The processing circuit 70 controls operations of the image sensor 30, the storage device 50, and the output device 60. The processing circuit 70 classifies the fluorescent dyes included in the target scene 10 by type. The details of this operation will be described below. A computer program executed by the processing circuit 70 is stored in the memory 72, which is, for example, a ROM or a RAM (Random Access Memory). As described above, the imaging apparatus 100 includes a processing device including the processing circuit 70 and the memory 72. The processing circuit 70 and the memory 72 may be integrated into one circuit board or provided on separate circuit boards. The functions of the processing circuit 70 may be distributed among circuits.

A method for classifying plural types of fluorescent dyes in the target scene 10 will now be described. This classification method includes the following steps (1) to (3).

(1) Luminance pattern data is generated for each of the plural types of fluorescent dyes. The luminance pattern data is data generated by predicting a luminance pattern detected when the fluorescent dye is imaged by the image sensor 30. That is, luminance pattern data A1 corresponding to fluorescent dye A1, . . . , and luminance pattern data An corresponding to fluorescent dye An are generated (n is a natural number greater than or equal to 1). The luminance pattern data includes pixel values corresponding to pixels included in the luminance pattern on a one-to-one basis. More specifically, the luminance pattern data is data that is predicted to be generated when a virtual scene in which the corresponding fluorescent dye spreads throughout the scene is imaged by the image sensor 30 through the filter array 20. The luminance pattern indicates the spatial distribution of luminance values at the pixels. Each of the luminance values is proportional to a value obtained by integrating, for the target wavelength range, a function obtained by multiplying together the transmission spectrum of the corresponding filter and the fluorescence spectrum of the fluorescent dye. When a region in which each type of fluorescent dye spreads in the target scene 10 is fixed, luminance pattern data may be generated from a virtual scene in which each type of fluorescent dye spreads not throughout the scene but in a part of the scene.

(2) The target scene 10 is imaged by the image sensor 30 through the filter array 20 to thereby generate compressed image data of the target scene 10.

(3) The luminance pattern data is compared with the compressed image data to thereby check whether each type of fluorescent dye is present in the target scene.

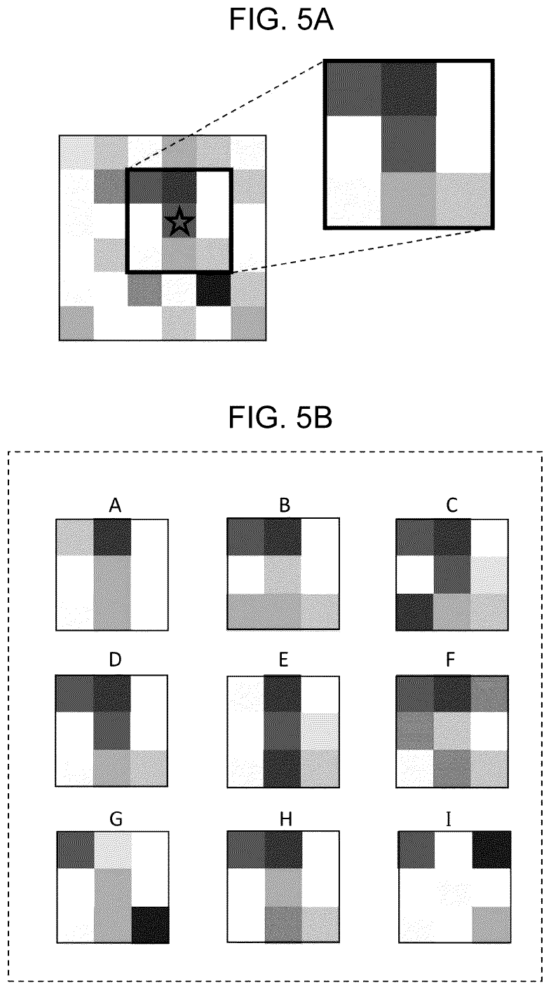

An example in which the fluorescence spectra of nine types of fluorescent dyes A to I are known and the optical transmittances, in nine bands, of each filter included in the filter array 20 are known will be described below with reference to FIG. 5A and FIG. 5B.

FIG. 5A is a diagram schematically illustrating a spatial distribution of luminance values in a part of a compressed image. A fluorescent dye, among the nine types of fluorescent dye, from which the luminance value of an evaluation pixel marked with a star illustrated in FIG. 5A is derived is determined not only on the basis of the luminance value of the evaluation pixel but also with reference to the luminance values of pixels positioned around the evaluation pixel. In the specification, a region in which the pixels to be referenced are included is referred to as “reference region”. Although the reference region is a square region formed of three rows and three columns and outlined by a thick line in the example illustrated in FIG. 5A, the shape of the reference region is not limited to a square shape. The evaluation pixel marked with a star is a pixel positioned in the center of the square region.

FIG. 5B is a diagram schematically illustrating spatial distributions of luminance in a region the same as the reference region illustrated in FIG. 5A in nine luminance patterns A to I predicted from the nine types of fluorescent dyes A to I, respectively. Labels A to I indicate luminance patterns A to I, respectively. In the specification, the term “reference region” is used also for the luminance patterns as in the compressed image.

The spatial distribution of luminance in the reference region of the compressed image illustrated in FIG. 5A matches the spatial distribution of luminance in the reference region of luminance pattern D illustrated in FIG. 5B. Therefore, it can be found that fluorescent dye D is present in a part, in the target scene 10, corresponding to the evaluation pixel marked with a star in FIG. 5A. Such pattern fitting may be performed by, for example, searching for a luminance pattern, among nine luminance patterns A to I, with which the MSE (Mean Squared Error) or PSNR (Peak Signal to Noise Ratio) between the luminance pattern and the compressed image in the reference region is minimized. Alternatively, the pattern fitting may be performed by machine learning. When the pattern fitting described above is performed for all pixels of the compressed image, whether each type of fluorescent dye is present in the target scene can be checked.

The pattern matching rate of matching between a luminance pattern and the compressed image at each pixel can be expressed by a numerical value on the basis of, for example, the MSE or PSNR. The pattern matching rate is also the probability of presence of a fluorescent dye at each pixel of the compressed image. The “probability of presence of a fluorescent dye at each pixel of the compressed image” means the probability of presence of a fluorescent dye in a part, in the target scene 10, corresponding to each pixel of the compressed image.

When the number of pixels included in the reference region is minimum, pattern fitting can be performed most efficiently. A method for determining the reference region will be described below. This method is effective for any fluorescence spectrum.

It is assumed that nine bands are used at minimum to classify nine types of fluorescent dyes. A luminance value gₓ at an evaluation pixel x is expressed by expression (3) below, where tₖ denotes the optical transmittance of the filter in a k-th band and Iₖ denotes the fluorescence intensity of the fluorescent dye in the k-th band.

$${g}_{x} = {\sum }_{k = 1}^{9} {t}_{k} {I}_{k} \qquad ( 3 )$$

The luminance value gₓ is a value obtained by adding together the product of the optical transmittance of the filter and the fluorescence intensity of the fluorescent dye for all bands. When the luminance value gₓ and the optical transmittance tₖ of the filter are known, expression (3) is an equation having nine variables Iₖ. When there are nine simultaneous equations at minimum, the nine variables Iₖ can be derived. As described above, the reference region includes pixels in three rows and three columns centered around the evaluation pixel x. In this embodiment, one type of fluorescent dye is present in the reference region, the transmission spectra of nine filters included in the reference region are different from each other, and the optical transmittance tₖ of each filter is non-zero for all of the nine bands. In this case, the nine variables Iₖ can be derived.

The number of types of fluorescent dyes and the number of bands are further generalized, and it is assumed that n bands are used to classify m types of fluorescent dyes. This is equivalent to the state in which the order of k in expression (3) becomes n. When the following requirements (A) to (D) are satisfied in this embodiment, pattern fitting can be performed most efficiently.
(A) The reference region includes n pixels including an evaluation pixel and pixels positioned near the evaluation pixel.
(B) Not plural types but one type of fluorescent dye is present in the reference region.
(C) The transmission spectra of n filters included in the reference region are different from each other.
(D) The transmittance tₖ of each filter is non-zero for all of the n bands.

In the requirement (A), “pixels positioned near the evaluation pixel” are pixels selected in ascending order of the center-to-center distance from the evaluation pixel. In the example illustrated in FIG. 5A, pixels for which the center-to-center distance from the evaluation pixel is shortest are four pixels positioned above, below, to the left, and to the right of the evaluation pixel, and pixels for which the center-to-center distance from the evaluation pixel is second shortest are four pixels positioned above and to the left, above and to the right, below and to the left, and below and to the right of the evaluation pixel. When, for example, the reference region includes seven pixels, the seven pixels include an evaluation pixel, the four pixels for which the center-to-center distance from the evaluation pixel is shortest, and any two pixels among the four pixels for which the center-to-center distance from the evaluation pixel is second shortest.

The requirement (D) is not satisfied in a case of a filter array used in monochrome cameras, RGB cameras, and existing snapshot-type hyperspectral cameras. In the requirement (D), “the transmittance tₖ is non-zero” means that a pixel signal of the image sensor that detects transmitted light passing through a filter having the transmittance tₖ has a value that is significantly large compared with noise. The filter array 20 suitable for generating hyperspectral image data is also suitable for pattern fitting.

Note that two or more types of fluorescent dyes may coexist in the reference region. For example, when fluorescent dye A and fluorescent dye E evenly coexist, the variable Iₖ described above is the average value of the fluorescence intensity of fluorescent dye A and the fluorescence intensity of fluorescent dye E in the k-th band. When two or more types of fluorescent dyes coexist in the reference region, the variable Iₖ is not limited to the average value of fluorescence intensities corresponding to the respective coexisting fluorescent dyes. The variable Iₖ may be, for example, the weighted average obtained by multiplication by a weight corresponding to, for example, the type of each dye or the median value.

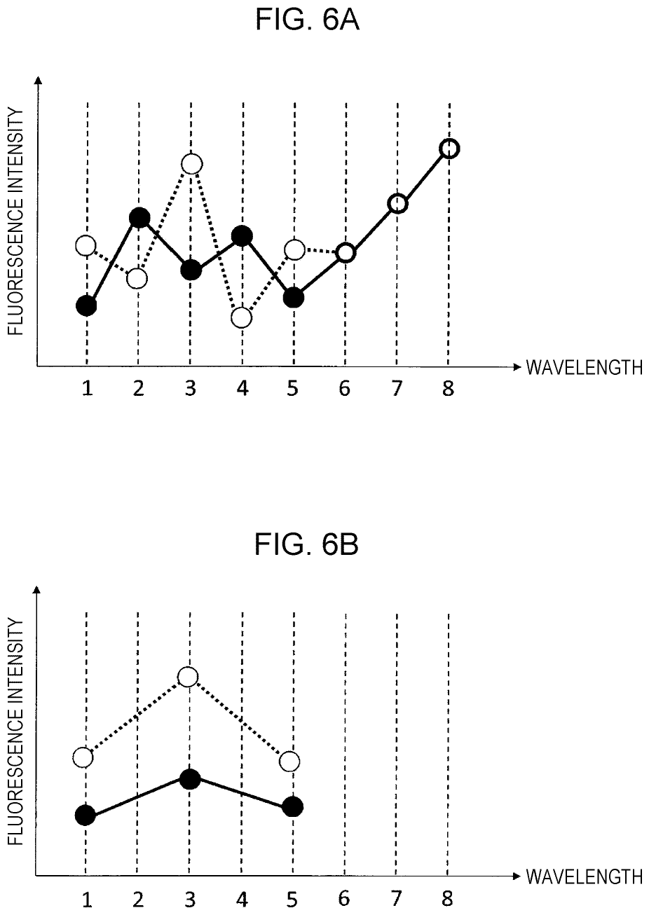

A method for determining bands to be used in classification of fluorescent dyes will now be described with reference to FIG. 6A and FIG. 6B. FIG. 6A is a diagram schematically illustrating the fluorescence intensities of two types of fluorescent dyes in bands 1 to 8. Each bandwidth is about several nm. In the example illustrated in FIG. 6A, the fluorescence intensities of the two types of fluorescent dyes are equal in bands 6 to 8. These bands are not necessary for classifying the two types of fluorescent dyes. Therefore, bands used in classification of the fluorescent dyes can be reduced from bands 1 to 8 to bands 1 to 5. The use of a dimensionality reduction technique allows further reduction from bands 1 to 5. FIG. 6B is a diagram schematically illustrating the fluorescence intensities of the two types of fluorescent dyes in bands 1, 3, and 5. In the example illustrated in FIG. 6B, bands used in classification of the fluorescent dyes are reduced from bands 1 to 5 to bands 1, 3, and 5 with the dimensionality reduction technique. As the dimensionality reduction technique, for example, AutoEncoder, Principal Component Analysis, or Singular Value Decomposition can be used.

When the bands used in classification of fluorescent dyes are known, a reference region that satisfies the requirements (A) to (D) described above can be selected. The number of bands used in classification of fluorescent dyes increases together with the number of types of fluorescent dyes. That is, the number of two or more pixels included in the reference region changes in accordance with the number of types of fluorescent dyes.

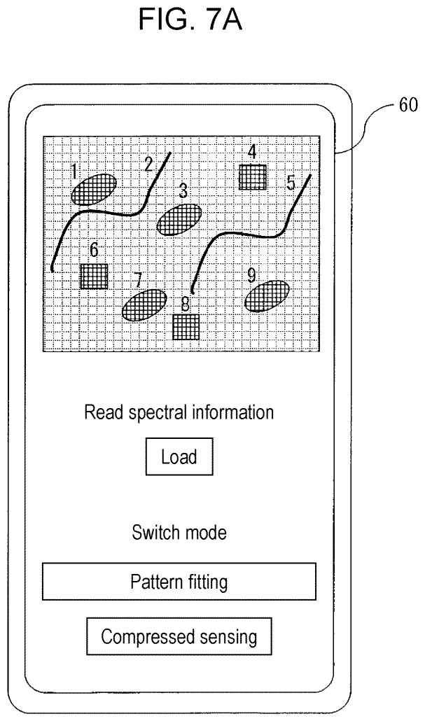

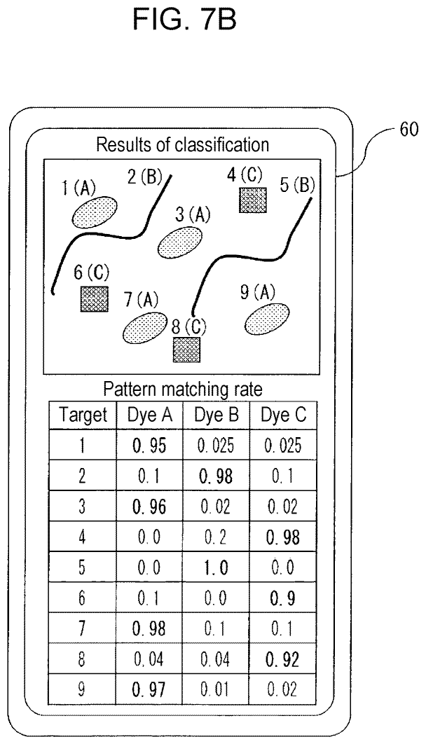

Example GUIs displayed on the output device 60 will now be described with reference to FIG. 7A and FIG. 7B. FIG. 7A is a diagram schematically illustrating an example GUI displayed on the output device 60 before classification of fluorescent dyes. The output device 60 illustrated in FIG. 7A is a display of a smartphone.

In the upper part of the GUI illustrated in FIG. 7A, a compressed image of a target scene is displayed. The target scene includes nine observation targets, which are assigned numbers 1 to 9. To each of the observation target, any of fluorescent dyes A to C whose fluorescence spectra are known is attached.

The observation targets can be extracted from the compressed image by, for example, edge detection. When the positions of the observation targets are known, pattern fitting can be performed only for pixels at which the observation targets are positioned in the compressed image. Therefore, pattern fitting need not be performed for all pixels.

Near the center of the GUI illustrated in FIG. 7A, a load button for reading spectral information of the fluorescent dyes is displayed. In response to the user selecting the button, the processing circuit 70 receives a signal indicating button selection, reads the dye data and the reconstruction table from the storage device 50, and generates luminance pattern data for each type of fluorescent dye. The dye data includes fluorescence spectral information of fluorescent dyes A to C.

In the lower part of the GUI illustrated in FIG. 7A, a button for pattern fitting and a button for compressed sensing are displayed. These buttons are buttons for the user to give an instruction for performing pattern fitting or compressed sensing. In response to the user selecting the button for pattern fitting, the processing circuit 70 receives a signal indicating button selection and compares the luminance pattern data with the compressed image data to thereby determine which fluorescent dye is attached to each of the observation targets in the target scene 10.

FIG. 7B is a diagram schematically illustrating an example GUI displayed on the output device 60 after classification of the fluorescent dyes. In the upper part of the GUI illustrated in FIG. 7B, observation targets 1 to 9 in the target scene are displayed, and next to each of numbers 1 to 9 of the observation targets, a corresponding one of labels A to C by type of fluorescent dye is added. In the example illustrated in FIG. 7B, fluorescent dye A is attached to elliptic observation targets 1, 3, 7, and 9, fluorescent dye B is attached to bent-line-shaped observation targets 2 and 5, and fluorescent dye C is attached to rectangular observation targets 4, 6, and 8. In the example illustrated in FIG. 7B, in response to the user selecting the number of an observation target, the processing circuit 70 may receive a signal indicating selection and make a graph of the spectrum of a fluorescent dye attached to the observation target and explanatory text about the fluorescent dye be displayed on a GUI.

In the lower part of the GUI illustrated in FIG. 7B, a table showing the pattern matching rates of matching between each of observation targets 1 to 9 and fluorescent dyes A to C is displayed. Each pattern matching rate for each observation target illustrated in FIG. 7B indicates the degree of matching of the predicted luminance pattern data with the compressed image data. Each pattern matching rate for each observation target illustrated in FIG. 7B can be obtained by, for example, averaging the pattern matching rates at pixels included in the observation target. A fluorescent dye attached to each observation target is a fluorescent dye having a pattern matching rate exceeding 0.9 among fluorescent dyes A to C. In the example illustrated in FIG. 7B, a pattern matching rate exceeding 0.9 for each observation target is indicated in boldface.

In the example illustrated in FIG. 7B, the highest pattern matching rate among the pattern matching rates of fluorescent dyes A to C for each observation target exceeds 0.9, which means that the accuracy of classification of the fluorescent dyes is likely to be high. The highest pattern matching rate falling below 0.9 means that the accuracy of classification of the fluorescent dye is unlikely to be high. In this case, an “unknown” label indicating that classification is not possible may be displayed next to the number of the observation target instead of any of labels A to C. The “unknown” label may be displayed when, for example, a pattern matching rate for an observation target does not satisfy a predetermined criterion. The criterion for a pattern matching rate may be set by the user. The “unknown” label is an example of an image displayed when a pattern matching rate is insufficient to classify the type of observation target. Alternatively, the user may return to the GUI illustrated in FIG. 7A and select the button for compressed sensing. The processing circuit 70 receives a signal indicating button selection, generates hyperspectral image data of the target scene by using a technique of compressed sensing, and compares the hyperspectral image data of the target scene with the dye data of the fluorescent dyes to thereby determine whether each type of fluorescent dye is present in the target scene. Alternatively, when the highest pattern matching rate falls below 0.9, the processing circuit 70 may display on a GUI, a message for encouraging the user to generate hyperspectral image data of the target scene by compressed sensing. Alternatively, when the highest pattern matching rate falls below 0.9, the processing circuit 70 may automatically determine whether each type of fluorescent dye is present in the target scene by using a technique of compressed sensing. When known dye data is not available, the user selects the button for compressed sensing without selecting the button for pattern fitting.

Note that the compressed image data can be used by another application. In this case, on the GUI illustrated in FIG. 7A, a button for selecting the other application may be further displayed in addition to the button for pattern fitting and the button for compressed sensing.

When the type of fluorescent dye attached to an observation target is determined in accordance with the shape of the observation target, the type of fluorescent dye may be classified according to the shape of the observation target. In this case, the dye data further includes information about the shape of distribution of each fluorescent dye in addition to the spectral information of the fluorescent dye. In the example illustrated in FIG. 7B, fluorescent dyes A to C are attached to the elliptic, bent-line-shaped, and rectangular observation targets, respectively.

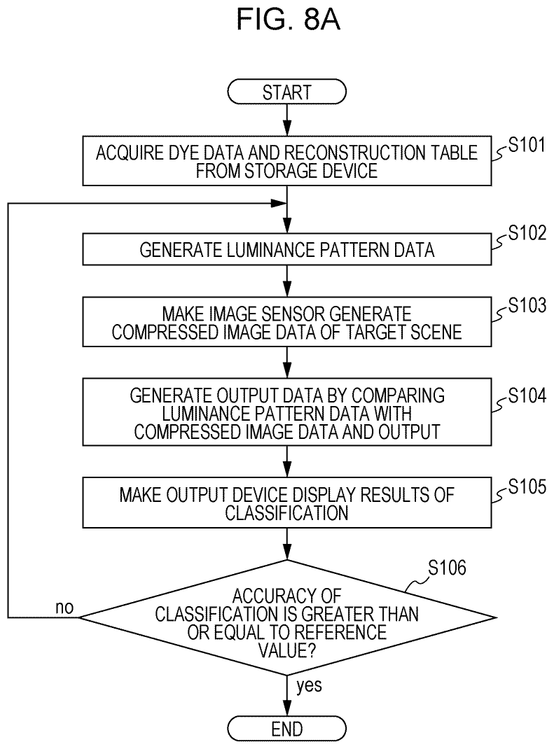

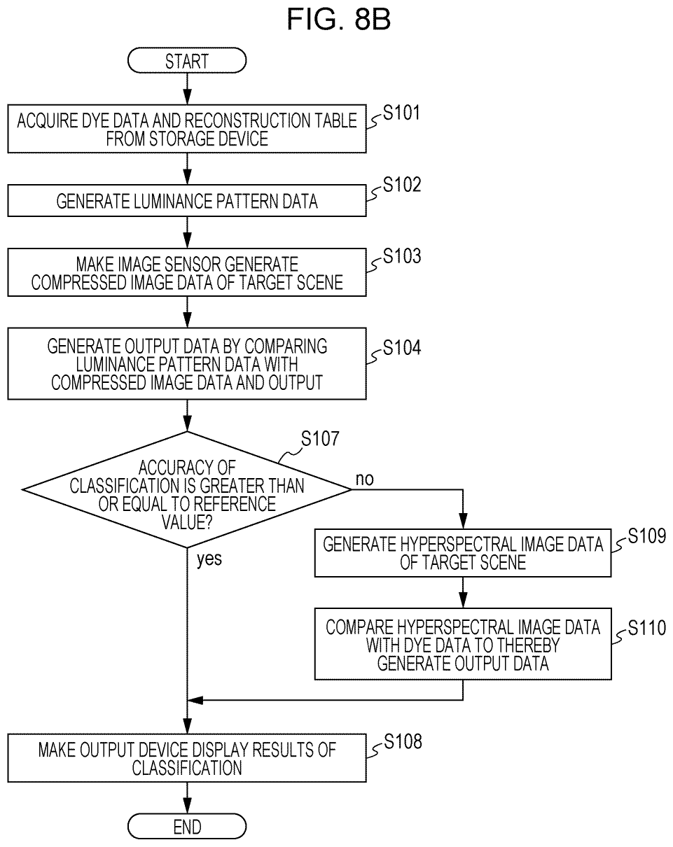

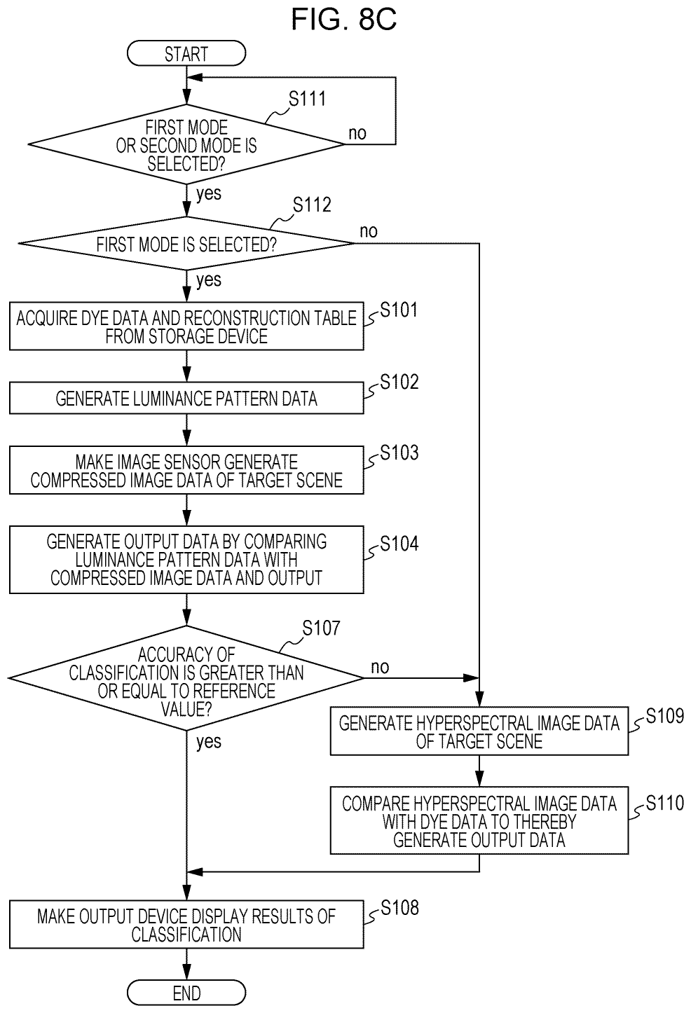

Examples of operations performed by the processing circuit 70 in classification of fluorescent dyes will now be described with reference to FIG. 8A to FIG. 8C. FIG. 8A is a flowchart illustrating an example of operations performed by the processing circuit 70. The processing circuit 70 performs operations in steps S101 to S106 described below.

### Step S101

The processing circuit 70 acquires the dye data and the reconstruction table from the storage device 50.

### Step S102

The processing circuit 70 generates pieces of luminance pattern data for plural respective types of fluorescent dyes.

### Step S103

The processing circuit 70 makes the image sensor 30 image the target scene 10 through the filter array 20 and generate compressed image data.

### Step S104

The processing circuit 70 generates output data indicating whether each type of fluorescent dye is present in the target scene by comparing the pieces of luminance pattern data with the compressed image data and outputs the output data. The output data can include, for example, label information by type of fluorescent dye, added to a part in which an observation target is present in the target scene. The output data can include, for example, information about the probability of presence of each fluorescent dye at each pixel of the compressed image and/or information about the probability of presence of each fluorescent dye at pixels corresponding to an observation target in the compressed image. The processing circuit 70 may store the output data in the storage device 50.

### Step S105

The processing circuit 70 makes the output device 60 output the results of classification indicated by the output data as illustrated in FIG. 7B.

### Step S106

The processing circuit 70 determines whether the accuracy of classification is greater than or equal to a reference value. This determination can be performed on the basis of, for example, whether the highest pattern matching rate among the pattern matching rates of fluorescent dyes A to C for each of observation targets 1 to 9 is greater than or equal to 0.9. If the determination results in Yes, the processing circuit 70 ends the operations. If the determination results in No, the processing circuit 70 performs steps S102 to S106 again. If the accuracy of classification is less than the reference value even in the second determination, the processing circuit 70 may perform steps S102 to S106 again or end the operations.

In the imaging apparatus 100 according to this embodiment, compressed image data is used in pattern fitting, which removes the need to reconstruct a hyperspectral image. As a result, compared to a configuration in which a hyperspectral image is reconstructed, the processing load for classifying a subject in a target scene by type can be reduced to a large degree. In the imaging apparatus 100 according to this embodiment, a GPU or an FPGA used in high-speed processing is not necessary as the processing circuit 70, and a low-spec CPU is sufficient. In the imaging apparatus 100 according to this embodiment, the processing speed is about 100 times higher than in the configuration in which a hyperspectral image is reconstructed. In the imaging apparatus 100 according to this embodiment, each filter included in the filter array 20 need not be a narrowband filter, which can attain a high sensitivity and a high spatial resolution.

When the accuracy of classification is less than the reference value, the processing circuit 70 may determine whether each type of fluorescent dye is present in the target scene by automatically using a technique of compressed sensing. FIG. 8B is a flowchart illustrating another example of operations performed by the processing circuit 70. The processing circuit 70 performs operations in steps S101 to S104 and operations in steps S107 to S110 described below. The operations in steps S101 to S104 illustrated in FIG. 8B are the same as the operations in steps S101 to S104 illustrated in FIG. 8A, respectively.

### Step S107

The processing circuit 70 determines whether the accuracy of classification is greater than or equal to the reference value. If the determination results in Yes, the processing circuit 70 performs the operation in step S108. If the determination results in No, the processing circuit 70 performs the operation in step S109.

### Step S108

The processing circuit 70 makes the output device 60 output the results of classification indicated by the output data.

### Step S109

The processing circuit 70 generates hyperspectral image data of the target scene on the basis of the compressed image data and the reconstruction table.

### Step S110

The processing circuit 70 compares the hyperspectral image data with the dye data to thereby generate output data. Subsequently, the processing circuit 70 performs the operation in step S108.

Furthermore, the user may switch between pattern fitting and compressed sensing. The processing circuit 70 makes the output device 60 display a GUI for the user to give an instruction for switching between a first mode for pattern fitting and a second mode for compressed sensing. The processing circuit 70 performs pattern fitting in response to a user's instruction for the first mode or performs compressed sensing in response to a user's instruction for the second mode.

FIG. 8C is a flowchart illustrating yet another example of operations performed by the processing circuit 70. The processing circuit 70 performs operations in steps S111 and S112 described below and operations in steps S101 to S104 and S107 to S110. The operations in steps S101 to S104 and S107 to S110 illustrated in FIG. 8C are the same as the operations in steps S101 to S104 and S107 to S110 illustrated in FIG. 8B, respectively.

### Step S111

The processing circuit 70 determines whether the first mode or the second mode is selected by the user, that is, whether the processing circuit 70 receives a signal indicating button selection of the first mode or the second mode. If the determination results in Yes, the processing circuit 70 performs the operation in step S112. If the determination results in No, the processing circuit 70 performs the operation in step S111 again.

### Step S112

The processing circuit 70 further determines whether the first mode is selected, that is, whether the received signal is a signal indicating the first mode. If the determination results in Yes, the processing circuit 70 performs the operation in step S101. If the determination results in No, the result means that the second mode is selected, that is, the received signal is a signal indicating the second mode, and therefore, the processing circuit 70 performs the operation in step S109.

### Embodiment 2

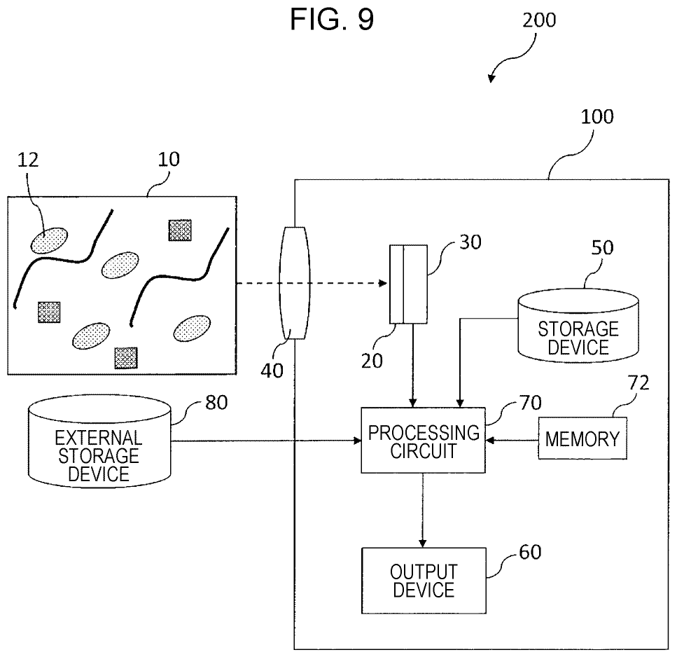

The storage device 50 included in the imaging apparatus 100 need not store the dye data. Furthermore, the storage device 50 included in the imaging apparatus 100 need not store the dye data or the reconstruction table. An example configuration of an imaging system according to embodiment 2 of the present disclosure will now be described with reference to FIG. 9. FIG. 9 is a block diagram schematically illustrating a configuration of an imaging system 200 according to exemplary embodiment 2 of the present disclosure. The imaging system 200 illustrated in FIG. 9 includes the imaging apparatus 100 illustrated in FIG. 4 and an external storage device 80. Note that in the specification, the term “imaging system” is used also for the imaging apparatus 100 illustrated in FIG. 4.

In an example of embodiment 2, the storage device 50 included in the imaging apparatus 100 stores the reconstruction table and the external storage device 80 stores the dye data. In step S101 illustrated in FIG. 8A, the processing circuit 70 acquires the reconstruction table from the storage device 50 and acquires the dye data from the external storage device 80.

In another example of embodiment 2, the external storage device 80 stores the reconstruction table and the dye data. In step S101 illustrated in FIG. 8A, the processing circuit 70 acquires the dye data and the reconstruction table from the external storage device 80.

### Embodiment 3

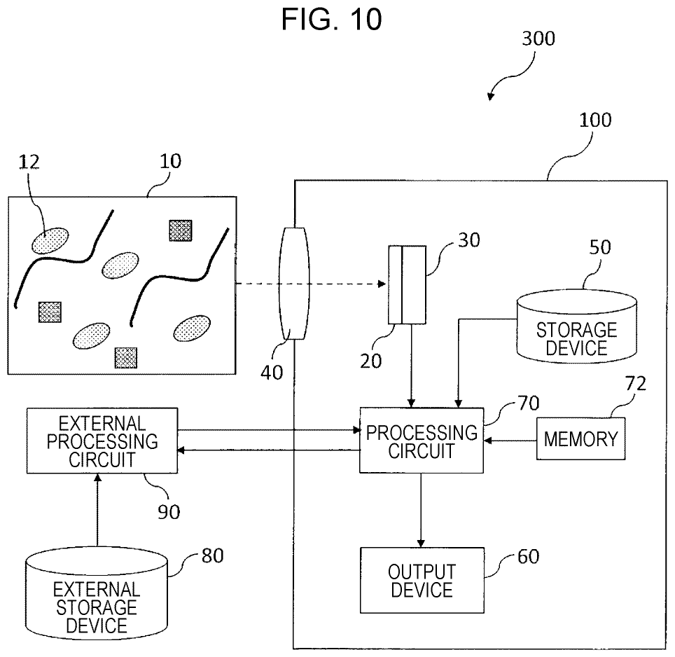

The processing circuit 70 included in the imaging apparatus 100 need not generate luminance pattern data. An example configuration of an imaging system according to embodiment 3 of the present disclosure will now be described with reference to FIG. 10. FIG. 10 is a block diagram schematically illustrating a configuration of an imaging system 300 according to exemplary embodiment 3 of the present disclosure. The imaging system 300 illustrated in FIG. 10 includes the imaging apparatus 100 illustrated in FIG. 4, the external storage device 80 that stores the reconstruction table and the dye data, and an external processing circuit 90. In the imaging system 300 according to embodiment 3, the external processing circuit 90 generates luminance pattern data.

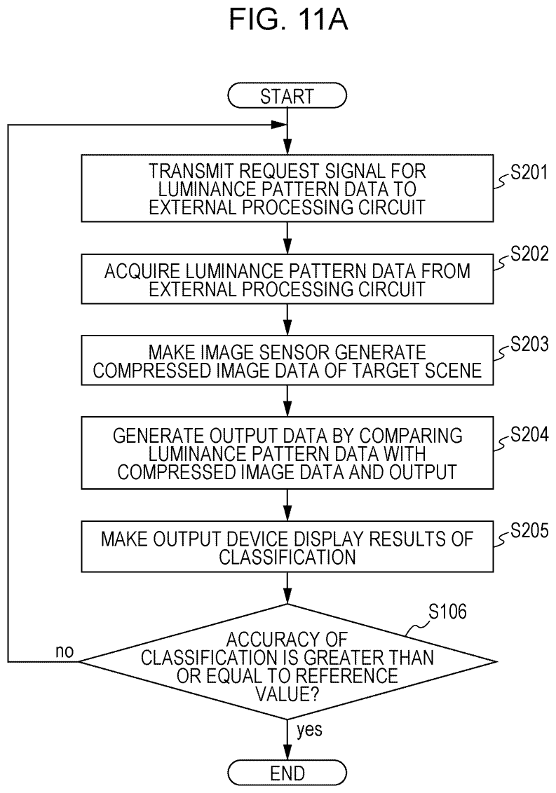

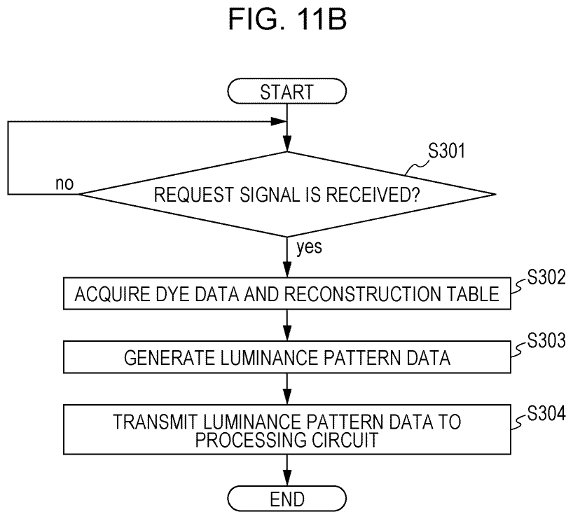

An example of operations performed by the processing circuit 70 and the external processing circuit 90 will now be described with reference to FIG. 11A and FIG. 11B. FIG. 11A is a flowchart illustrating an example of operations performed by the processing circuit 70. The processing circuit 70 performs operations in steps S201 to S206 described below.

### Step S201

The processing circuit 70 transmits a request signal for requesting pieces of luminance pattern data to the external processing circuit 90.

### Step S202

The processing circuit 70 acquires the pieces of luminance pattern data from the external processing circuit 90.

### Steps S203 to S206

The operations in steps S203 to S206 are the same as the operations in steps S103 to S106 illustrated in FIG. 8A, respectively. However, the operation in step S206 is different from the operation in step S106 in that if the determination results in No, the processing circuit 70 performs steps S201 to S205 again.

FIG. 11B is a flowchart illustrating an example of operations performed by the external processing circuit 90, between step S201 and step S202 illustrated in FIG. 11A. The external processing circuit 90 performs operations in steps S301 to S304 described below.

### Step S301

The external processing circuit 90 determines whether the request signal is received. If the determination results in Yes, the external processing circuit 90 performs the operation in step S302. If the determination results in No, the external processing circuit 90 performs the operation in step S301 again.

### Step S302

The external processing circuit 90 acquires the dye data and the reconstruction table from the external storage device 80.

### Step S303

The external processing circuit 90 generates pieces of luminance pattern data on the basis of the dye data and the reconstruction table.

### Step S304

The external processing circuit 90 transmits the pieces of luminance pattern data to the processing circuit 70.

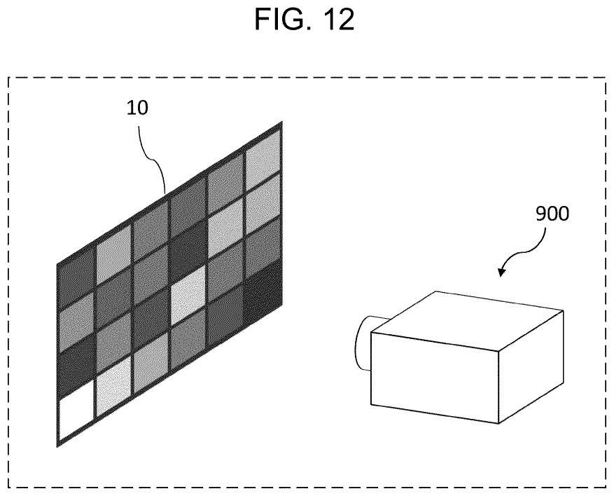

A method for checking whether pattern fitting is used in an imaging apparatus will now be described with reference to FIG. 12.

FIG. 12 is a diagram schematically illustrating example imaging of a color chart by an imaging apparatus 900, as the target scene 10. In the color chart, color regions in different colors are distributed in a mosaic pattern, and color boundaries are clear. Instead of a color chart, a sheet to which different types of fluorescent substances are applied in a mosaic pattern may be used.

In the present embodiments, when the reference region includes one type of spectral information, a subject included in the target scene 10 can be classified. For example, in two adjacent color regions in different colors, when the reference region is positioned only within one of the color regions, a high accuracy of classification can be attained. In contrast, when the reference region extends across the two color regions, that is, when the reference region includes a part of each of the color regions, the accuracy of classification decreases to a large degree. This is because the reference region includes two types of spectral information. When the color chart is repeatedly shifted little by little and imaged and the accuracy of classification decreases to a large degree, it can be found that pattern fitting is used in the imaging apparatus 900.

Furthermore, in the present embodiments, the number of pixels included in the reference region changes in accordance with spectral information and the number of subjects included in the subject data. When the reference region is displayed on an output device (not illustrated) of the imaging apparatus 900 and when the number of pixels included in the reference region changes with a change in the subject data, it can be found that pattern fitting is used in the imaging apparatus 900.

Furthermore, when the GUIs as illustrated in FIG. 7A and FIG. 7B are displayed on the output device (not illustrated) of the imaging apparatus 900, it can be found that pattern fitting is used in the imaging apparatus 900.

### Application to Foreign Matter Inspection

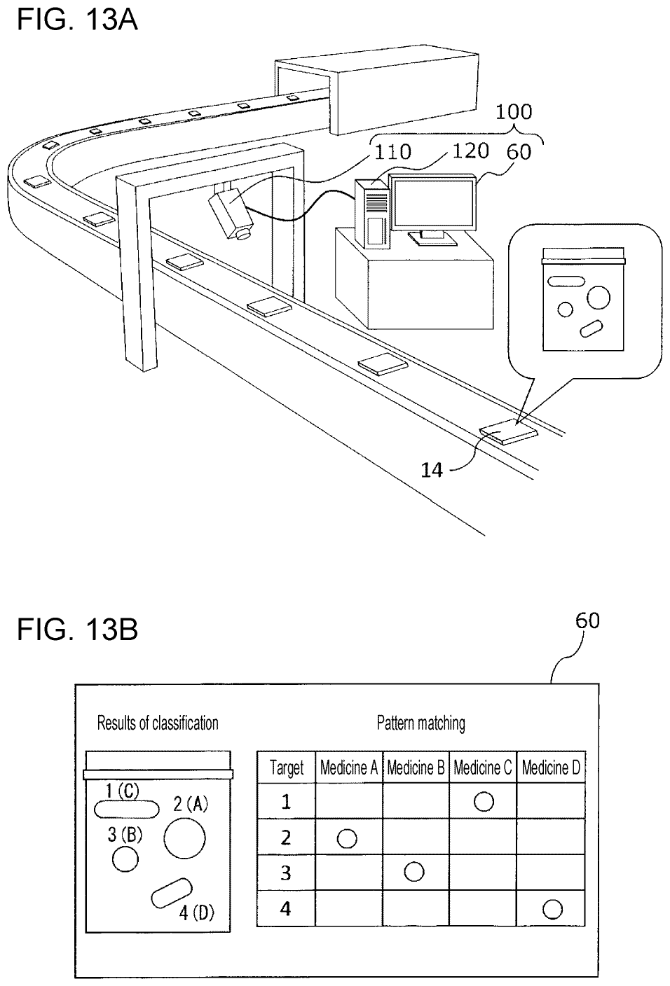

The imaging apparatus 100 according to embodiments 1 to 3 can also be used in, for example, a foreign matter inspection in addition to classification of fluorescent dyes. An example application of the imaging apparatus 100 according to embodiments 1 to 3 will now be described with reference to FIG. 13A and FIG. 13B. Although a foreign matter inspection for medicines will be described here as an example, the imaging apparatus 100 may be applied to, for example, a foreign matter inspection for electronic components.

FIG. 13A is a diagram schematically illustrating example individual imaging by the imaging apparatus 100, of medicine sachets 14 conveyed by a belt conveyor. The imaging apparatus 100 illustrated in FIG. 13A includes a camera 110, a processing device 120, and the output device 60. The camera 110 illustrated in FIG. 13A includes the filter array 20, the image sensor 30, and the optical system 40 illustrated in FIG. 4. The processing device 120 illustrated in FIG. 13A includes the storage device 50, the processing circuit 70, and the memory 72 illustrated in FIG. 4. Each medicine sachet 14 contains large and small tablet-type medicines A and B and large and small capsule-type medicines C and D. Spectral information of medicines A contained in the medicine sachets 14 remains almost the same. The same applies to medicines B to D. The storage device 50 stores medicine data including spectral information of medicines A to D.

FIG. 13B is a diagram schematically illustrating an example GUI displayed on the output device 60 after classification of the medicines. In the left part of the GUI illustrated in FIG. 13B, observation targets 1 to 4 in the target scene are displayed, and next to each of numbers 1 to 4 of the observation targets, a corresponding one of labels A to D by type of medicine is added. In the right part of the GUI illustrated in FIG. 13B, a table showing pattern matching between observation targets 1 to 4 and medicines A to D is displayed. In the example illustrated in FIG. 13B, observation target 1 is medicine C, observation target 2 is medicine A, observation target 3 is medicine B, and observation target 4 is medicine D. In the table, for each observation target, a medicine, among medicines A to D, having a pattern matching rate of 90% or more is marked with a circle. In the example illustrated in FIG. 13B, it can be found that the medicine sachet 14 contains medicines A to D and that the medicine sachet 14 does not contain medicines of the same type, a medicine other than medicines A to D, or a foreign matter.

### Other Matter 1

Modifications of the embodiments of the present disclosure may be as follows.

An imaging system comprising:
a filter array that includes filters having transmission spectra, the filters corresponding one-to-one to the transmission spectra, the transmission spectra being different from each other;
an image sensor that generates pixel values in response to light coming from the filter array; and
a processing circuit, wherein
the processing circuit acquires first pixel values obtained by a calculation based on information indicating a spectral characteristic of a substance and information indicating the transmission spectra,
the calculation is performed on condition that light from the substance is incident on the filter array and the image sensor generates the first pixel values in response to light being produced in response to the incident light,
the processing circuit acquires second pixel values, the image sensor generating second pixel values by imaging a target scene through the filter array, and
the processing circuit determines whether the target scene includes the substance on the basis of the first pixel values and the second pixel values.

The substance may be a fluorescent substance.

### Other Matter 2

In the present disclosure, the luminance pattern data and the compressed image may be generated by imaging with a method different from imaging using the filter array that includes the optical filters.

For example, in a configuration of the imaging apparatus 100, the image sensor 30 may be processed to thereby change the light receiving characteristics of the image sensor on a pixel-by-pixel basis and the processed image sensor 30 may be used to perform imaging to thereby generate image data. That is, instead of the filter array 20 coding light to be incident on the image sensor, the image sensor may be provided with a function of coding incident light to thereby generate the luminance pattern data and the compressed image. In this case, the reconstruction table corresponds to the light receiving characteristics of the image sensor.

Furthermore, a configuration in which an optical element, such as a meta-lens, is introduced into at least a part of the optical system 40, thereby changing the optical characteristics of the optical system 40 spatially and wavelength-wise and coding incident light may be employed, and an imaging apparatus including this configuration may generate the luminance pattern data and the compressed image. In this case, the reconstruction table is information corresponding to the optical characteristics of the optical element, such as a meta-lens. The imaging apparatus 100 having the above-described configuration different from the configuration using the filter array 20 may be used to thereby modulate the intensity of incident light on a wavelength-by-wavelength basis, generate the compressed image and the luminance pattern data, and generate the output data regarding whether a substance is present in a target scene.

That is, the present disclosure may include the following form.

An imaging system including:
an imaging apparatus that includes light receiving regions having different photoresponse characteristics; and
a processing circuit, in which
the processing circuit
acquires luminance pattern data generated on the basis of subject data including spectral information of at least one substance, the luminance pattern data being generated by predicting a luminance pattern detected when the substance is imaged by the imaging apparatus,
acquires first image data obtained by imaging a target scene by the imaging apparatus, and
generates output data regarding whether the substance is present in the target scene by comparing the luminance pattern data with the first image data.

Each of the light receiving regions may correspond to a pixel included in the image sensor.

The imaging apparatus may include an optical element, and the photoresponse characteristics of the light receiving regions may correspond to the spatial distribution of the transmission spectrum of the optical element.

### Other Matter 3

Each embodiment to which various modifications conceived by a person skilled in the art are made and a form formed of a combination of constituent elements in different embodiments are also included in the scope of the present disclosure without departing from the gist of the present disclosure.

The imaging apparatus in the present disclosure can be used in classification of a subject included in a target scene by type. Furthermore, the imaging apparatus in the present disclosure can be used in a foreign matter inspection.

What is claimed is:

1. An imaging system comprising:
a filter array that includes filters having different transmission spectra;
an image sensor that images light passing through the filter array and generates image data; and
a processing circuit, wherein
the processing circuit
acquires luminance pattern data generated on the basis of subject data that includes spectral information of at least one substance, the luminance pattern data being generated by predicting a luminance pattern detected when the substance is imaged by the image sensor,
acquires first image data obtained by imaging a target scene by the image sensor, and
generates output data regarding whether the substance is present in the target scene by comparing the luminance pattern data with the first image data.

2. The imaging system according to claim 1, further comprising:
a storage device that stores the subject data and a table showing a spatial distribution of the transmission spectra of the filter array, wherein
the processing circuit acquires the subject data and the table from the storage device and generates the luminance pattern data on the basis of the subject data and the table.

3. The imaging system according to claim 1, further comprising:
a storage device that stores a table showing a spatial distribution of the transmission spectra, wherein
the processing circuit acquires the table from the storage device, externally acquires the subject data, and generates the luminance pattern data on the basis of the subject data and the table.

4. The imaging system according to claim 1, wherein
the processing circuit externally acquires the luminance pattern data.

5. The imaging system according to claim 1, wherein
the spectral information of the at least one substance includes spectral information of substances, and
the output data is data regarding whether each of the substances is present in the target scene.

6. The imaging system according to claim 1, wherein
the processing circuit determines whether the substance is present in the target scene by comparing the luminance pattern data with the first image data in a reference region that includes two or more pixels.

7. The imaging system according to claim 6, wherein
the number of the two or more pixels included in the reference region changes in accordance with the number of substances.

8. The imaging system according to claim 6, wherein
a target wavelength range for which light separation is performed by the imaging system includes n bands,
the two or more pixels included in the reference region include n pixels including an evaluation pixel and a pixel near the evaluation pixel,
not plural substances but one substance is present in the reference region,
the filter array includes n filters corresponding to the n respective pixels included in the reference region, the n filters having different transmission spectra, and
each of the n filters has a transmittance that is non-zero for all of the n bands.

9. The imaging system according to claim 1, wherein
the output data includes information about a probability of presence of the substance at each pixel of the first image data and/or information about a probability of presence of the substance at pixels, in the first image data, corresponding to an observation target.

10. The imaging system according to claim 1, wherein
the subject data further includes shape information of the at least one substance.

11. The imaging system according to claim 1, further comprising:
an output device, wherein
the processing circuit makes the output device output a result of classification indicated by the output data.

12. The imaging system according to claim 11, wherein
the output device displays an image in which a label by type is added to a part in which the substance is present in the target scene.

13. The imaging system according to claim 11, wherein
the output device displays at least one of a graph of a spectrum of the substance or an image showing explanatory text about the substance.

14. The imaging system according to claim 11, wherein
the output device displays an image in which a label is added to an observation target, in the target scene, for which a probability of presence of the substance falls below a specific value, the label indicating that classification of a type of the observation target is not possible.

15. The imaging system according to claim 1, wherein
each of the filters has two or more local maxima in a target wavelength range for which light separation is performed by the imaging system.

16. The imaging system according to claim 1, wherein
the filters include four or more types of filters, and the four or more types of filters include a type of filter having a passband that overlaps a part of a passband of another type of filter.

17. The imaging system according to claim 1, wherein
the first image data is compressed image data coded by the filter array, and
the processing circuit generates hyperspectral image data of the target scene on the basis of the compressed image data of the target scene.

18. The imaging system according to claim 11, wherein
the first image data is compressed image data coded by the filter array, and
the processing circuit
makes the output device display a GUI for a user to give an instruction for generating hyperspectral image data of the target scene, and
generates in response to the instruction given by the user, the hyperspectral image data of the target scene on the basis of the compressed image data of the target scene.

19. The imaging system according to claim 11, wherein
the first image data is compressed image data coded by the filter array, and
the processing circuit
makes the output device display a GUI for a user to give an instruction for switching between a first mode for generating the output data and a second mode for generating hyperspectral image data of the target scene,
generates the output data in response to an instruction for the first mode given by the user, and
generates the hyperspectral image data of the target scene in response to an instruction for the second mode given by the user, on the basis of the compressed image data of the target scene.

20. A method to be performed by a computer,
the method comprising:
acquiring first image data obtained by imaging a target scene by an image sensor, the image sensor imaging light passing through a filter array that includes filters having different transmission spectra and generating image data;
acquiring luminance pattern data generated on the basis of subject data that includes spectral information of at least one type of subject, the luminance pattern data being generated by predicting a luminance pattern detected when the subject is imaged by the image sensor; and
generating output data indicating whether the subject is present in the target scene by comparing the luminance pattern data with the first image data.

21. A storage medium storing a program for causing a computer to perform a process, the storage medium being a nonvolatile computer-readable medium,
the process comprising:
acquiring first image data obtained by imaging a target scene by an image sensor, the image sensor imaging light passing through a filter array that includes filters having different transmission spectra and generating image data;
acquiring luminance pattern data generated on the basis of subject data that includes spectral information of at least one type of subject, the luminance pattern data being generated by predicting a luminance pattern detected when the subject is imaged by the image sensor; and
generating output data indicating whether the subject is present in the target scene by comparing the luminance pattern data with the first image data, and outputting the output data.

22. An imaging system comprising:
a first region;
an image sensor; and
a processing circuit, wherein
the first region includes filters having transmission spectra, the filters corresponding to the transmission spectra on a one-to-one basis, the transmission spectra being different from each other,
the image sensor generates pixel values in response to light coming from the first region,
the processing circuit acquires first pixel values obtained by a calculation based on information indicating a spectral characteristic of a substance and information indicating the transmission spectra,
the calculation is made in such a manner that light from the substance is incident on the first region and the image sensor generates the first pixel values in response to light being produced in response to the incident light,
the processing circuit acquires second pixel values generated by the image sensor imaging a target scene through the first region,
the processing circuit determines whether the target scene includes the substance on the basis of the first pixel values and the second pixel values, and
the first region is included in the image sensor or the first region is not included in the image sensor.
